(19) United States
(12) Patent Application Publication
(10) Pub. No.: US 2010/0328385 A1
(43) Pub. Date: Dec. 30, 2010

(54) INK JET PRINTING APPARATUS AND INK JET PRINTING METHOD

(75) Inventors: Tsuyoshi Shibata, Yokohama-shi (JP); Makoto Akahira, Yokohama-shi (JP); Hiromitsu Yamaguchi, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/817,534

(22) Filed: Jun. 17, 2010

(30) Foreign Application Priority Data
Jun. 24, 2009 (JP) 2009-150072

(51) Int. Cl. B41J 29/38

(52) U.S. Cl. 347/12

(57) ABSTRACT

The present invention provides an ink jet printing apparatus configured to allow the ejection performance of a print head with a large number of nozzles densely arranged therein to be kept in a favorable condition by preliminary ejection and to enable degradation of images caused by the preliminary ejection to be alleviated. Preliminary ejection data generation unit is provided which generates preliminary ejection data designed to allow ink not contributing to image printing to be ejected through nozzles 103A and 103B in a print head 21-1. The preliminary ejection data generation unit generates preliminary ejection data designed to allow the ink to be preliminarily ejected onto a print medium through the nozzles 103B, which are included in the plural types of nozzles and which offer a smaller ejection amount than the other nozzles 103A.

### BACKGROUND OF THE INVENTION

1. Field of the Invention

The present invention relates to an ink jet printing apparatus and an ink jet printing method in which a print head including nozzles with different ink ejection amounts eject ink onto a print medium.

2. Description of the Related Art

In general, when nozzles arranged in a print head in an ink jet printing apparatus are left with no ink ejected through the nozzles for a long time, ink existing near ejection ports maybe thickened. In this case, a non-ejection condition may occur in which no ink is ejected even when ejection energy generation elements provided in the nozzles are driven. Thus, blanks may be generated in images. Furthermore, even if the nozzles in the print head can avoid the non-ejection condition, thickened ink in the nozzles may lead to an abnormal ejection condition in which an ink ejection direction deviates from the appropriate one or an appropriate amount of ink fails to be ejected. This may degrade image quality. The maximum idle time for which an improper ejection with degree which affects an image such as non-ejection or abnormal ejection is prevented from occurring in the nozzles is hereinafter referred to as an appropriate idle time.

A recovery process is conventionally performed in order to allow a printing operation to be started after the appropriate idle time has elapsed. In the recovery process, the thickened ink in the nozzles is discharged, and ink suitable for an ejection operation is filled into the nozzles to recover the ejection performance of the nozzles. Known recovery processes include a forced discharge scheme in which a negative pressure or a positive pressure is applied to the inside of the nozzles in the print head to forcibly suck or push out the ink through the nozzles and preliminary ejection in which heaters in the nozzles are driven to eject the ink as is the case with the normal printing operation. In a serial printing apparatus configured to move the print head in a direction crossing the direction in which a print medium is conveyed, a forced recovery process based on the above-described forced discharge scheme or the preliminary ejection is carried out after the print head has been moved to a cap or an ink reception section located at an end of a scan path. In particular, in the preliminary ejection process, the print head moves to the ink reception section to carry out the preliminary ejection at intervals of a given period or a given number of scans regardless of the use/nonuse of the nozzles and a printing amount. Thus, the preliminary ejection requires movement from a scan area (print scan area) in which the print medium is printed to the ink reception section and from the ink reception section to the print area. This significantly increases printing time compared to the case in which the preliminary ejection is not carried out.

On the other hand, in current ink jet printing apparatuses for which effort has been made to improve image quality, even if only one dot is ejected onto a blank print medium, the ejected dot is changed into fine fractions to the level at which the fractions are visually indiscernible. Thus, even if several dots other than dots required to form an image in a printable area on the print medium are ejected, the quality of the image formed is almost prevented from being degraded. However, in order to form fine dots, it is necessary to reduce the diameter of the ejection port of each nozzle and to set the amount of ink ejected per operation to a very small value. Hence, the thickened ink may greatly affect ink ejection performance. Therefore, the preliminary ejection needs to be more frequently carried out in accordance with the reduced diameter of the ejection port. This results in a decrease in throughput.

To solve these problems, Japanese Patent Laid-Open No. 2004-098298 discloses the following technique. Ejection data required to print an image on a print medium is synthesized with ejection data required to preliminarily eject ink onto the print medium. Thus, an image print pattern and a preliminary ejection pattern are mixed on the print medium. This printing method eliminates the need to move the print head to the ink reception section every time a predetermined number of print scans are finished. This allows print throughput to be improved. Furthermore, the preliminary ejection involves formation of only several dots, thus preventing the quality of the printed image from being significantly degraded. Moreover, the preliminary ejection is avoided for nozzles being used for printing. Thus, the execution of the preliminary ejection can be limited to nozzles requiring preliminary ejection that exceeds an excess idle time. Hence, compared to the method of carrying out the preliminary ejection regardless of the use/nonuse of the nozzles, the technique according to Japanese Patent Laid-Open No. 2004-098298 advantageously prevents ink from being wasted, thus enabling a reduction in ink consumption. As a result, printing with high image quality can be accomplished.

Furthermore, for the recent print heads, not only the diameter of the ejection port is reduced as described above but also the density and number of nozzles formed tends to be increased. In connection with this tendency, for improved quality and gradation of print images, there has been a demand to use a print head with plural types of ejection ports through which different amounts of ink is ejected, to further increase the speed of the printing operation.

In the print head in which plural types of many ejection ports with different amounts of ink ejected therethrough are densely arranged as described above, when the preliminary ejection pattern is synthesized with the image print pattern for all the nozzles, the image quality may be affected. That is, the preliminary ejection onto the print medium is effective for increasing the print speed, but a print head with many nozzles densely arranged therein requires a large number of preliminary ejections of ink onto the print medium. Thus, dots formed by the preliminary ejection unavoidably affect the image.

In this case, a reduction in the number of preliminary ejections required for each print scan enables an unallowable variation in the density of the image to be avoided. However, moisture evaporates quickly from nozzles with small ejection amounts. Thus, the reduction in the number of preliminary ejections for each print scan may unavoidably increase the viscosity of the ink in the nozzles, resulting in non-ejection. Furthermore, ink containing a solvent unlikely to evaporate may be used. However, this poses new problems such as a decrease in the speed at which the ink is fixed to the print medium.

### SUMMARY OF THE INVENTION

An object of the present invention is to provide an ink jet printing apparatus configured to use preliminary ejection to allow the ejection performance of a print head with many nozzles densely arranged therein to be kept in a favorable condition and to enable degradation of images resulting from preliminary ejection to be alleviated.

To accomplish this object, the present invention is configured as follows.

A first aspect of the present invention provides an ink jet printing apparatus comprising: a print unit configured to print dots of different sizes on a print medium based on image print data, by use of a print head including plural types of nozzles with different ejection amounts to eject ink onto the print medium; and, a generation unit for generating preliminary ejection data for preliminary ejection, wherein the generation unit generates preliminary ejection data designed to allow ink to be preliminarily ejected onto the print medium through those of the plurality of nozzles which have a smaller ejection amount than the other nozzles.

A second aspect of the present invention provides an ink jet printing apparatus configured to use a print head including plural types of nozzles with different ejection amounts to eject ink onto a print medium based on image print data, thus forming dots of different sizes on the print medium, the apparatus comprising: a generation unit for generating preliminary ejection data for preliminary ejection, wherein the generation unit generates preliminary ejection data designed to allow ink to be preliminarily ejected, at a predetermined timing, onto the print medium through those of the plurality of nozzles which have a smaller ejection amount than the other nozzles, while allowing the ink to be preliminarily ejected, at a timing different from the predetermined timing, onto the print medium through the other nozzles.

A third aspect of the present invention provides an ink jet printing method of using a print head including plural types of nozzles with different ejection amounts to eject ink onto a print medium based on image print data, thus forming dots of different sizes on the print medium, the method comprising: a generation step of generating preliminary ejection data for preliminary ejection, wherein the generation step generates preliminary ejection data designed to allow ink to be preliminarily ejected onto the print medium through those of the plurality of nozzles which have a smaller ejection amount than the other nozzles.

The present invention uses preliminary ejection to allow the ejection performance of a print head with many nozzles densely arranged therein to be kept in a favorable condition and enables degradation of images resulting from preliminary ejection to be alleviated.

Further features of the present invention will become apparent from the following description of exemplary embodiments (with reference to the attached drawings).

### BRIEF DESCRIPTION OF THE DRAWINGS

FIG. 1 is a plan view schematically showing the configuration of an inkjet printing apparatus according to an embodiment of the present invention;

FIG. 2A is a diagram schematically showing a head unit used in a first embodiment of the present invention;

FIG. 2B is an enlarged view schematically showing a print head 21-1 shown in FIG. 2A;

FIG. 3 is a block diagram schematically showing the configuration of a control system according to the present embodiment;

FIG. 4 is a flowchart showing an example of a process procedure carried out according to the present embodiment to synthesize preliminary ejection data with image print data;

FIG. 5 is a schematic diagram illustrating a basic print scan according to the present embodiment;

FIG. 6 is a schematic diagram illustrating a preliminary ejection operation according to a first embodiment;

FIG. 7 is a diagram showing the relationship between the diameter of a dot formed by a nozzle and an appropriate idle time;

FIG. 8 is a diagram showing the results of plotting, for each black ink dot size, of the level of granularity observed when two droplets are preliminarily ejected onto a blank print medium;

FIG. 9 is a schematic diagram illustrating a preliminary ejection operation according to a second embodiment;

FIG. 10 is a schematic diagram showing that dots formed by preliminary ejection are arranged in lines;

FIG. 11 is a schematic diagram illustrating a preliminary ejection operation according to a third embodiment;

FIG. 12 is a schematic diagram illustrating synthesis of a preliminary ejection pattern according to an embodiment of the present invention;

FIG. 13 is a diagram showing the relationship between the number of passes and the level of coloring as a color difference on a blank print medium observed when preliminary ejection through only small nozzles is carried out on the print medium and when preliminary ejection through both large and small nozzles is carried out on the print medium;

FIG. 14 is a diagram showing a pattern of dots formed by the preliminary ejection onto the print medium through the small nozzles in each of 1-pass print mode to 8-pass print mode;

FIG. 15 is a schematic diagram illustrating a preliminary ejection operation according to Embodiment 6;

FIG. 16 is a schematic diagram of a print head used in Embodiment 7 of the present invention;

FIG. 17 is a schematic diagram of a print head used in Embodiment 7 of the present invention; and

FIG. 18 is a schematic diagram showing a dot pattern for preliminary ejection carried out in Embodiment 8 of the present invention.

### DESCRIPTION OF THE EMBODIMENTS

Embodiments of the present invention will be described below in detail with reference to the drawings.

### First Embodiment

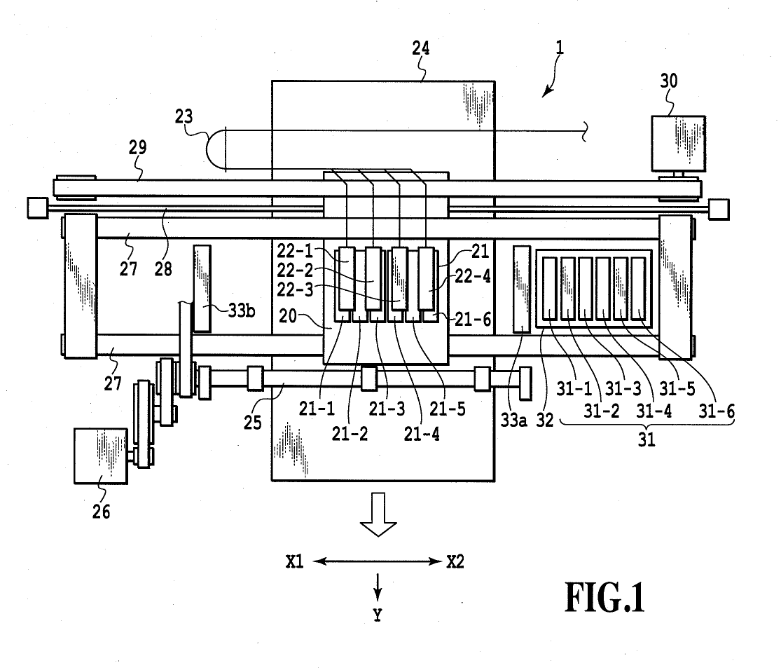

FIG. 1 is a plan view schematically showing the configuration of an ink jet printing apparatus 1 according to a first embodiment. The ink jet printing apparatus 1 according to the present embodiment includes a carriage 20 supported on and guided along a guide shaft 27 so as to be movable in a main scanning direction (X direction). A head unit 21 is mounted on the carriage 20. The head unit 21 includes a plurality of ink jet print heads (hereinafter simply referred to as print heads) capable of ejecting ink. Reference numerals 21-1 to 21-6 denote print heads configured to eject ink in cyan (C), magenta (M), black (K), yellow (Y), magenta (M), and cyan (C), respectively. A plurality of ejection ports P1 and P2 are arranged in each of the print heads 21-1 to 21-6; each of the ejection ports P1 and P2 is an opening formed at the tip of a corresponding nozzle through which the ink is ejected. Each of the print heads 21-1 to 21-6 is supplied with ink stored in four ink cartridges 22-1 to 22-4. In the head unit 21 according to the present embodiment, the print head capable of ejecting the cyan ink (cyan head) and the print head capable of ejecting the magenta ink (magenta head) are arranged at the respective positions in the main scanning direction (X direction) so as to separate from each other. Thus, the ink is fed from the cyan ink cartridge 22-1 and the magenta ink cartridge 22-4, each of which has a unitary configuration, to the print heads 21-1 and 21-6, respectively, via ink supply paths (not shown in the drawings).

Control signals and the like are transmitted to the print head 21 via a flexible cable 23. Print media 24 such as plain paper, high-grade exclusive paper, OHP sheets, gloss paper, gloss films, and postcards are sandwichingly held by a sheet discharge roller 25 via a conveyance roller (not shown in the drawings). Each of the print media 24 is driven by a conveyance motor 26 and fed in a Y direction (sub-scanning direction) shown by an arrow. The carriage 20 moves in a forward direction X1 and a backward direction X2 of the main scanning direction (X direction) along the guide shaft 27 together with a driving belt 29 driven and moved by a carriage motor 30. The position to which the carriage 20 moves is detected by a linear encoder 28 located along the main scanning direction.

Furthermore, the print head 21 includes nozzles each with an ejection port through which the ink is ejected and a liquid path communicating with the ejection port. A heat generation element (electrothermal conversion element) configured to generate heat energy for ink ejection is provided in the liquid path. In synchronism with the timing at which the linear encoder 28 carries out a read, the heat generation element provided in each nozzle is driven based on a print signal. The driven heat generation element generates heat and thus bubbles in the ink in the nozzle. The generation of the bubbles causes pressure to be exerted, thus allowing ink droplets to be ejected through the ejection port.

In a scan area in which the carriage 20 can move, a recovery unit 32 with a cap section 31 is installed at a home position set outside an area (print scan area) through which the print medium passes. During non-printing, the carriage 20 is moved to the home position to seal ink ejection port surfaces of the print heads 21 with caps 31-1 to 31-4 of the cap section 31. This enables prevention of thickening or fixation of the ink caused by evaporation of the solvent and an ink improper ejection resulting from foreign matter such as dust. Furthermore, in a recovery operation for an improper ejection or blockage in nozzles infrequently used, the cap section also serves as an ink reception section configured to receive the ink ejected through the nozzles during preliminary ejection carried out when a printing operation is started or finished or while a printing operation is being performed. Moreover, the cap section 31 is also used for a suction recovery operation in which with the ejection port surface of the print head 21 sealed, a pump (not shown in the drawings) communicating with the cap section 31 is actuated to suck and discharge ink unsuitable for ejection, for example, thickened ink, through the ejection of each nozzle.

Furthermore, paired ink reception sections 33a and 33b for preliminary ejection are provided outside and across the print scan area through which the print medium passes. Upon passing over the ink reception sections 33a and 33b, the print heads 21-1 to 21-9 can carry out preliminary ejection not contributing to image printing, so as to eject the ink onto the ink reception sections 33a and 33b. Additionally, a wiping member such as a blade (not shown in the drawings) may be placed adjacent to the cap section to clean the ink ejection port formation surface of the print head 21.

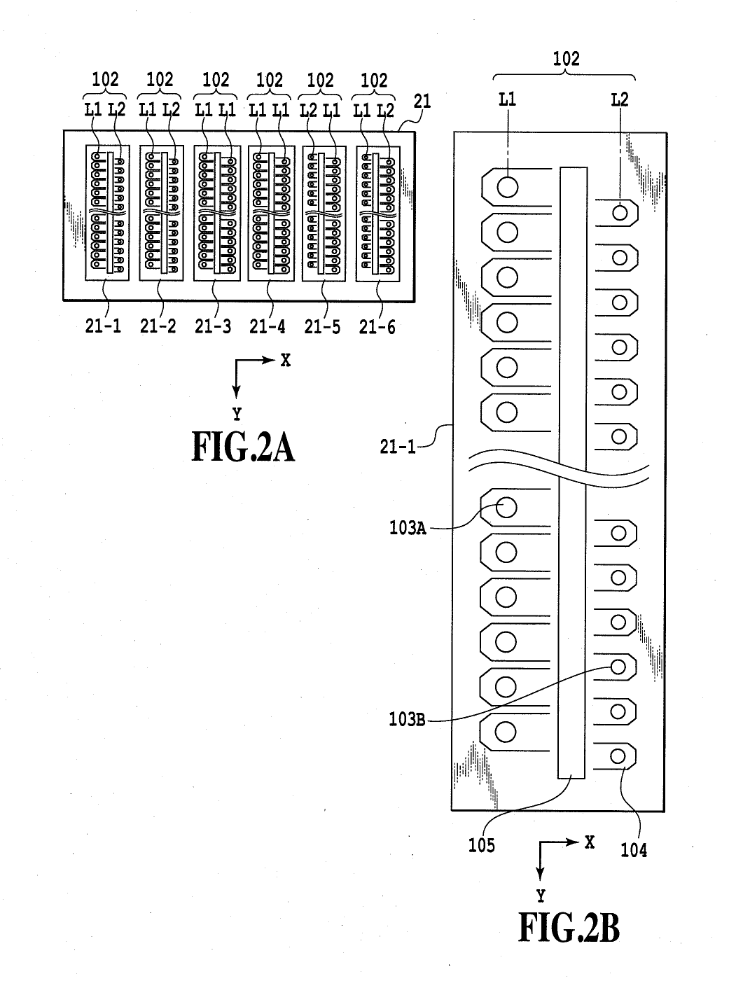

FIG. 2A is a diagram schematically showing an example of arrangement of the nozzles in the print heads 21-1 to 21-6 in the head unit 21. A plurality of nozzle groups 102 through which different types of ink can be ejected are arranged in the respective print heads. Two nozzle arrays are arranged in each nozzle group 102 across an ink supply port 105. In each of the nozzle arrays forming each nozzle group, the nozzles are arranged at the same pitch. The nozzles forming one of the nozzle arrays are misaligned with the corresponding nozzles forming the other nozzle array by a ½ pitch in an X direction.

Furthermore, in the head unit 21, the nozzle group 102 in each of the print head 21-1 for cyan ink ejection and the print head 21-2 for magenta ink ejection, both of which are positioned in the left of FIG. 2A, includes a first nozzle array L1 and a second nozzle array L2 as shown in FIG. 2B. A plurality of first nozzles 103A through each of which a predetermined amount of ink is ejected are arranged in the first nozzle array L1 along the longitudinal direction of the ink supply port 105. A plurality of second nozzles 103B through each of which ink the amount of which is smaller than in the first nozzle 103A is ejected are arranged in the second nozzle array L2. The term “ejection amount” as used herein means the amount of ink ejected through the nozzle by each driving operation performed on the electrothermal conversion element located in the nozzle. Furthermore, in the description below, the first nozzle is also referred to as a large nozzle, and the second nozzle is also referred to as a small nozzle. Additionally, the print head 21-6 for cyan ink ejection and the print head 21-5 for magenta ink ejection, both of which are positioned in the right of FIG. 2B, each have the first nozzle array L1 and the second nozzle array L2. However, the first and second nozzles L1 and L2 in each of the two print heads 21-6 and 21-5 are arranged so as to be misaligned with the first and second rows L1 and L2 in each of the above-described print heads 21-1 and 21-2 by a ½ pitch. When the large nozzles 103A and the small nozzles 103B are arranged in each of the print head for cyan ink and the print head for magenta ink as described above, cyan dots and magenta dots each with a size different from that of each cyan dot can be printed on the print medium. Furthermore, in the present embodiment, in the print head 21-3 for black ink ejection and the print head 21-4 for yellow ink ejection, both nozzle arrays forming the nozzle group 102 are the nozzle arrays L1 in which the first nozzles 103A are arranged. However, even in the print heads 21-3 and 21-4, the nozzles forming one of the two nozzle arrays are shifted with the corresponding nozzles forming the other nozzle array by a ½ pitch in the X direction.

In the present embodiment, an average of 2.5 ng of ink droplets are ejected through the large nozzle 103A, and an average of 1.2 ng of ink droplets are ejected through the large nozzle 103B. Furthermore, each nozzle group 102 includes the two nozzle arrays in which the nozzles are arranged at a nozzle density of 1,200 dpi in the X direction. The ink is fed from the ink supply port 105 to each nozzle 103 via an ink channel 104 corresponding to the nozzle 103.

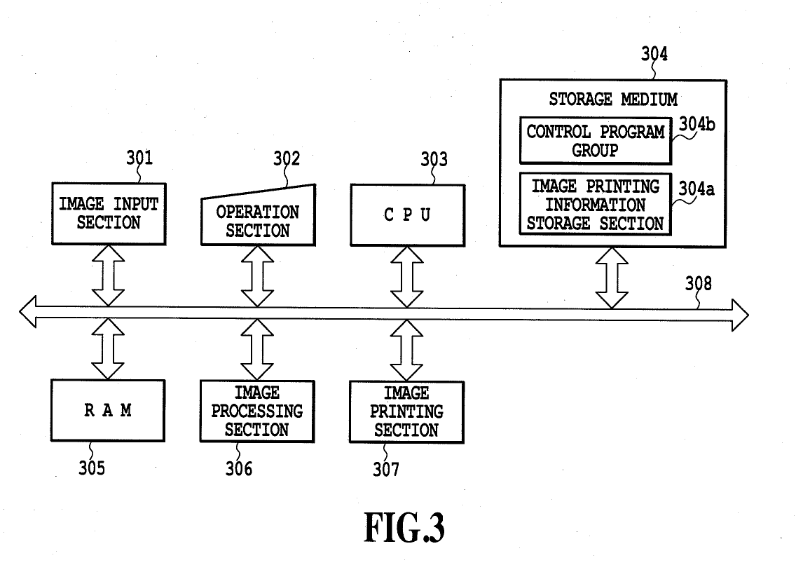

FIG. 3 is a block diagram schematically showing the configuration of a control system for the ink jet printing apparatus according to the present invention. In FIG. 3, reference numerals 301, 302, and 303 denote an image data input section, an operation section, and a CPU, respectively. Furthermore, reference numeral 304 denotes a storage medium configured to store various data and including an image printing information storage section 304a configured to store information on the print mode and the ink and information such as temperature and humidity during printing, and a group of various control programs 304b. Moreover, reference numeral 305 denotes a RAN configured to temporarily store various data. Reference numeral 306 denotes an image data processing section configured to generate and synthesize image data and preliminary ejection data described below. Reference numerals 307 and 308 denote an image printing section configured to output images and a bus section configured to transfer various data.

Each of the above-described sections will be described in further detail. The image data input section 301 is configured to receive multivalued image data from an image input apparatus such as a scanner or a digital camera and multivalued image data saved to a hard disk or the like in a personal computer. The operation section 302 includes various keys configured to set various parameters and to specify start of printing. The CPU 303 executes processes for calculations, determinations, and control in accordance with various programs to control the whole printing apparatus. The storage medium 304 is configured to store, for example, a program required to operate the printing apparatus in accordance with a control program and an error processing program. All the operations according to the present embodiment are performed in accordance with this program. The storage medium 304 configured to store the program may be a ROM, an FD, a CD-ROM, an HD, a memory card, a magnetooptical disk, or the like. The RAM 305 is used as a work area for the various programs in the storage medium 304, a temporary withdrawal area for error processing, and a work area for image processing. Furthermore, the RAM 305 can copy various tables in the storage tables 304 to the RAM 305 and then change the contents of the tables. The CPU 303 can carry out image processing with reference to the changed tables.

The image printing section 307 includes a drive circuit configured to drive the above-described print head configured to eject the ink based on ejection data generated by the image processing section 306 to form a dot image on the print medium as well as the electrothermal conversion element located in each of the nozzles in the print head. The bus line 308 is configured to transmit address signals, data, control signals, and the like in the apparatus.

Now, generation of print data required to eject the ink from the print head will be described.

The image processing section 306 separates input multivalued image data for each pixel into colors corresponding to the ink colors used. Then, the image processing section 306 quantizes the color-separated multivalued image data for each color into image data with a smaller tone number (N value). The image processing section 306 further converts the image data into binary image data corresponding to a tone value indicated by each quantized pixel. For example, a multivalued error diffusion method can be used to carry out N-level processing on input image data. However, the method for N-level processing is not limited to this aspect but may be any halftone processing method such as an average density preservation method or a dither matrix method. Furthermore, the above-described N-level processing results in binary image data corresponding to a pixel pattern for each gray level. The binary image data is then expanded into a bit map. The binary image data expanded into a bit map is distributed in association with the number of scans carried out in the same scan area. Thus, print data (hereinafter referred to as image print data) is generated which is required to print a binary image print pattern indicating whether or not to eject the ink through each nozzle in the print head for each print scan.

Furthermore, the image processing section 306 according to the present embodiment synthesizes image print data generated by the above-described data processing with data (first preliminary ejection data) required to print a preliminary ejection pattern. The image processing section 306 transmits data obtained by synthesizing the image print data with the first preliminary ejection data, to a print buffer in the RAM 305. The image processing section 306 then rearranges the data into ejection data required to allow the print head to eject the ink (HV conversion). The present embodiment determines idle nozzles based on dot count values to generate first preliminary ejection data. Thus, before the synthesized data is transmitted to the print buffer, only the image print data is transmitted to the print buffer. First, the idle time for each nozzle is calculated from a count value obtained by counting image print data transmitted to the print buffer and a carriage return time interval (time for each scan) based on sequence control during printing. Based on the results, nozzles for which the idle time is longer than a predetermined time are determined to be idle. Then, based on the idle nozzle determination, first preliminary ejection data is generated for each nozzle. That is, according to the present embodiment, the image print data is expanded into dummy ejection data on the print buffer to allow dot counting. After the dot counting, the required preliminary ejection data is generated and synthesized with the image print data. The resulting data is expanded into ejection data required for an actual printing operation. The image processing section 306 forms preliminary ejection data generation unit for carrying out a preliminary ejection data generation step of generating preliminary ejection data.

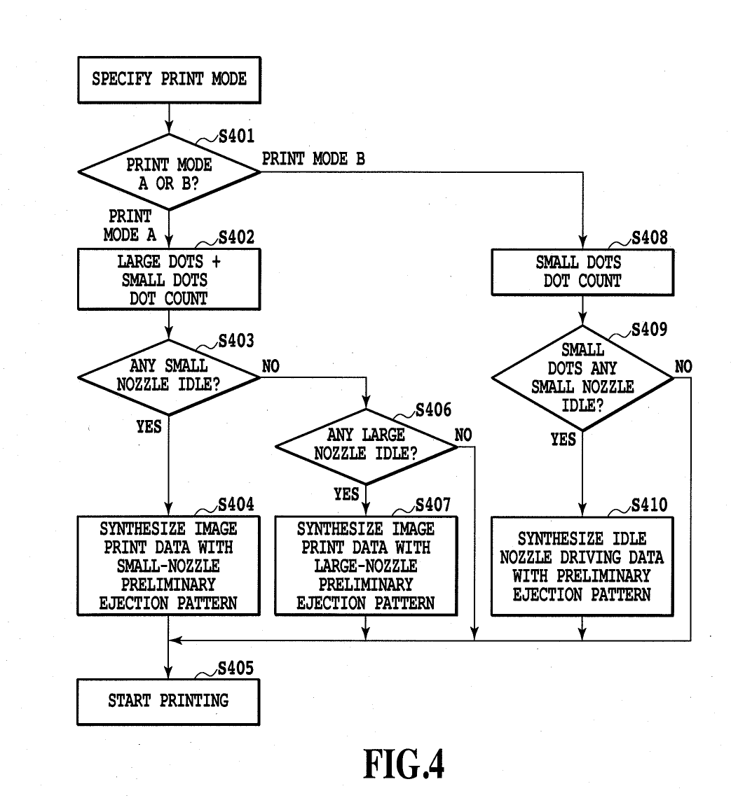

FIG. 4 is a flowchart showing an example of the procedure of a process for synthesizing the preliminary ejection data with the image print data.

In step S401, the image processing section 306 determines whether a print mode A or a print mode B has been specified; in the print mode A, both the large nozzles 103A and the small nozzles 103B in the print head are used for preliminary ejection, and in the print mode B, only the small nozzles 103B are used for preliminary ejection. In the present embodiment, for the print mode B, the number of scans (the number of passes) for multipass printing required to complete printing of an image in a predetermined area is set be larger than that for the print mode A. The print mode B is thus adapted for high-grade image printing. In the print mode B for such high-grade printing, when the large nozzles A are used to preliminarily eject the ink onto a sheet, the print image may be affected. Thus, in this mode, the preliminary ejection onto the sheet is not carried out. If the image processing section 306 determines in step S401 that the print mode A has been specified, the image processing section 306 shifts to the subsequent step S402. In step S402, the image processing section 306 counts the number of dots (small dots and large dots) to be printed by the large nozzles 103A and the small nozzles 103B during a print scan, that is, the numbers of ejections through the large nozzles 103A and the small nozzles 103B. The counting is based on binary image print data corresponding to the large and small nozzles. The image processing section 306 determines, based on the dot count values, whether or not any of the small nozzles are idle during the print scan (these small nozzles are hereinafter referred to as the idle small nozzles 103B) (step S403). Here, if any of the small nozzles are idle, the image processing section 306 determines that a preliminary ejection pattern needs to be synthesized for the small nozzles 103B. In the subsequent step S404, the image processing section 306 synthesizes the image print data with the preliminary ejection data required for the small nozzles.

Furthermore, in step S406, the image processing section 306 determines whether or not any of the large nozzles 103A are idle during the print scan (these large nozzles are hereinafter referred to as the idle large nozzles) (step S406). If none of the large nozzles are determined to be idle, then in step S407, the image processing section 306 synthesizes the preliminary ejection data (second preliminary ejection data) required for the large nozzles with the image data. In the above-described process, if any of the large and small nozzles are idle during each print scan, the preliminary ejection data corresponding to the nozzles some of which are idle is synthesized with the image data.

On the other hand, if the print mode specified in step S408 is determined to be the print mode B, the image processing section 306 counts the number of dots to be printed by the small nozzles 103B during the print scan (step S408). Based on the dot count value, the image processing section 306 determines whether or not any of the small nozzles 103B are idle during the print scan (step S409). If any of the small nozzles are idle, the image processing section 306 synthesizes the image print data with the preliminary ejection data corresponding to the small nozzles (step S410). If the preliminary ejection pattern is synthesized with the image print pattern by the above-described processing, then in the present embodiment, the large nozzles 103A undergo a preliminary ejection onto the ink reception sections 32a. The small nozzles 103B undergo a preliminary ejection onto the print medium 24.

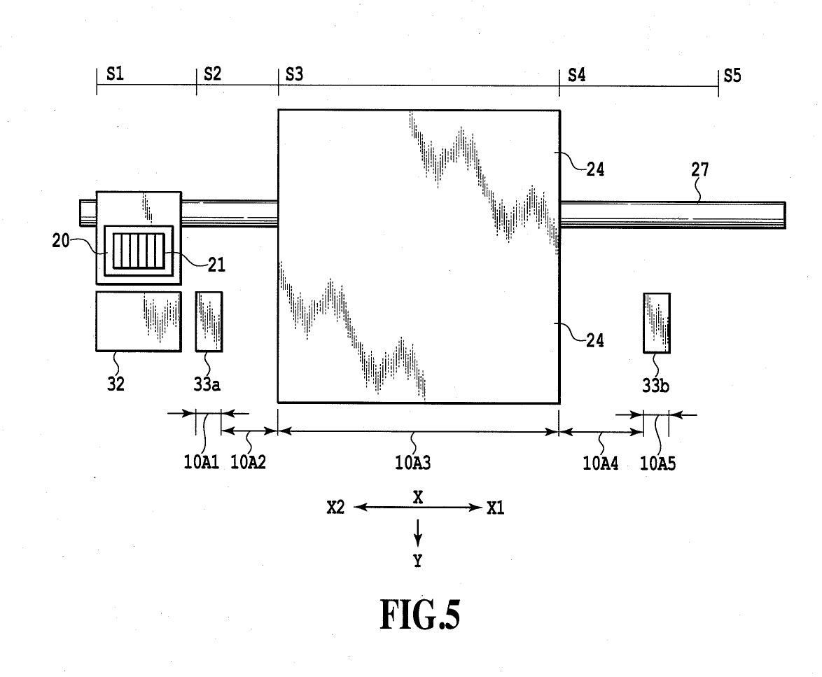

A basic print scan carried out by the ink jet printing apparatus configured as described above will be described with reference to FIG. 5. FIG. 5 is a diagram schematically showing the printing apparatus as seen from the bottom thereof.

The carriage 20 with the head unit 21 mounted thereon moves in the forward direction (X1 direction) from a home position S1 while being accelerated. Each print head starts an ink ejection operation (image printing operation) from a print start position S3 where a side end of the print medium is present. The print head ejects the ink onto the print medium 24 until the print head reaches a print end position S4 for a single print scan. The print head thus prints an image. Thereafter, the carriage 20 moves to the terminal S5 of the print area while being decelerated as required. A preliminary ejection is carried out when the carriage 20 passes over the ink reception section 33b. At this time, the print medium is fed by a predetermined amount depending on the print mode. When the preliminary ejection is finished, the carriage 20 reverses the moving direction and starts moving in the backward direction (X2 direction). The moving speed is then increased. Upon reaching the print start position S4 through the backward movement, the print head resumes the ejection operation. The print head continues to print an image until the print head reaches the print end position S3 for the backward scan. Thereafter, the print head moves to ink reception section 33b while being decelerated. The print head then carries out preliminary ejection. When the print medium is conveyed by the predetermined amount again, the print head starts moving in the forward direction to print an image. The above-described operation is repeated to complete image printing.

The above-described printing operation corresponds to what is called bidirectional printing in which the print head ejects the ink while moving in the forward and backward directions. In contrast, what is called unidirectional printing may be performed in which the printing is completed by only one of the forward and backward movements. In this case, the carriage 20 is moved at a higher speed during the scan (idle scan) in which printing is not performed. Thus, the print medium is not conveyed before the idle scan is started. Hence, a time required for the forward and backward operations of the print head is shorter for the unidirectional printing than for the bidirectional printing.

Furthermore, the cap section 31 and the wiping member (not shown in the drawings) are provided at the home position; the cap section 31 is used to suck the ink in the nozzles in the print head, and the wiping member wipes the ejection port surface of the print head. Thus, if particularly required, the print head may be moved to the home position, where the print head may undergo a suction recovery process and an ejection port surface wipe-off process over time. However, the scan in a normal printing operation for each page is such that the print head prints an image by carrying out repeated reciprocating scans between the ink reception sections 33a and 33b. If such a scan is carried out, the scan area during a printing operation performed by each print head can be divided as shown in FIG. 5. That is, the scan area during a printing operation performed by each print head can be divided into areas 10A1 and 10A5 where the print head moves over the ink reception sections 33a and 33b, an area 10A2 where the moving speed of the print head is accelerated and decelerated, an idle scan area 10A4, and an area 10A3 where the print head prints an image on the print medium. Furthermore, since the scanning direction needs to be reversed, areas 10A2 and 10A4 where the print head is accelerated and decelerated are also set.

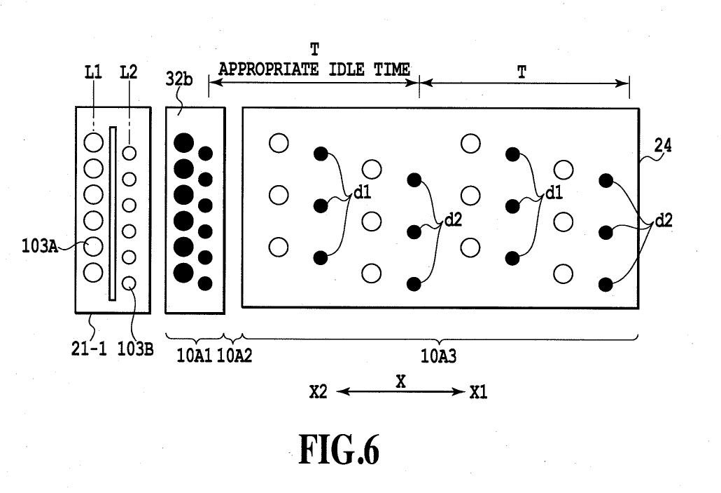

Now, the preliminary ejection operation according to the present embodiment will be described with reference to FIG. 6. Here, for simplification of description, only one nozzle group 101 through which the cyan ink is ejected is shown.

In the present embodiment, print media (for example, A4-sized print media) with a large print width in the main scanning direction (X direction) are used, and a short area is formed between the ink reception section 32b and the idle scan area. Furthermore, in FIG. 6, black dots indicate dots formed by an actual preliminary ejection. Furthermore, white dots indicate nozzles not subjected to preliminary ejection and are not formed by the preliminary ejection according to the present embodiment. Additionally, in the example shown in FIG. 6, in reciprocating scans, the print head 21-1 carries out unidirectional printing to eject the ink only while scanning in a given direction (X1 direction).

The present embodiment uses the print head 21-1 with the two types of nozzles (large nozzles 103A and small nozzles 103B) arranged therein and allowing two types of dots, large dots and small dots, to be formed. One pl of ink droplets are ejected through the small nozzles 103B, used to form small dots. Two pl of ink droplets are ejected through the large nozzles 103A, used to form large dots.

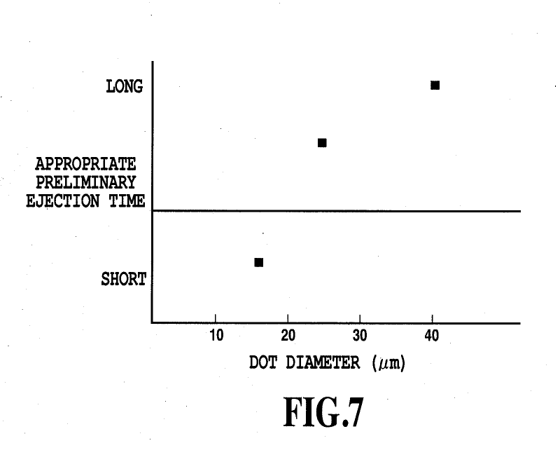

FIG. 7 is a diagram showing the relationship between the size of a dot (dot diameter) formed through the nozzle and the maximum idle time (hereinafter referred to as the appropriate idle time) for which non-ejection is prevented in the nozzle used to form the dot. Although depending on the environmental temperature and humidity, the characteristics of the ink and the print head, driving conditions, and the like, nozzles used to form dots with a larger diameter generally tend to involve a longer appropriate idle time. Nozzles used to form dots with a smaller diameter generally tend to involve shorter appropriate idle time. A solid line shown in FIG. 7 indicates a time required for each print scan (print scan time). The nozzles used to form a dot diameter corresponding to an appropriate idle time shorter than the print scan time are forcibly subjected to a preliminary ejection onto the print medium during each print scan.

In the present embodiment, if the printing apparatus is used in a low-temperature and low-humidity environment, the idle time during which no improper ejection occurs in the small nozzles in the print head (this idle time is hereinafter referred to as the appropriate idle time) is about 0.3 sec. Furthermore, if a serial printing apparatus performs a printing operation on A4-sized print media, two droplets are desirably preliminarily ejected through each small nozzle 103B during each print scan. Additionally, if the printing apparatus is similarly used in a low-temperature and low-humidity environment, the appropriate idle time for the large nozzles 103A is about 2.0 sec. One droplet is preliminarily ejected at intervals of two print scans.

Now, the preliminary ejection operation according to the present embodiment performed in association with the above-described print scan will be described.

First, when the print head 21-1 moves in the X1 direction to reach a position over the ink reception section 32b, the ink is preliminarily ejected onto the ink reception section 32b through each of the first and second nozzle arrays L1 and L2. Moreover, when the print head 210-1 passes through the idle scan area 10A2 to reach a position over the print medium 24, the ink is ejected through the nozzles based on the image print data. Furthermore, the second preliminary ejection through the small nozzles in the second nozzle array L2 is carried out on the print medium 24. Thereafter, the print head passes the print area on the print medium 24 and then stops. The print head then has its moving direction reversed to the X2 direction and returns to the position over the ink reception section 32a. No ink is ejected during the movement in the X2 direction.

During the scan in the X2 direction, in the second nozzle array L2, the ink is not simultaneously ejected through all the nozzles. Instead, the ink is ejected at different timings for the odd-numbered nozzles (odd nozzles) in the row and for the even-numbered nozzles (even nozzles) in the row. As a result, a pattern of dots formed on the print medium 24 is such that dots d1 formed through the odd nozzles and dots d2 formed through the even nozzles are dispersively printed without concentrating on the same line as shown in FIG. 7. This enables a reduction in the adverse effect of the dots formed by preliminary ejection on the image.

Furthermore, for both the odd- and even-numbered nozzles, the first preliminary ejection is carried out during the appropriate idle time following a preliminary ejection onto the ink reception section 32b. Thereafter, the second preliminary ejection is carried out during the appropriate idle time T (0.3 sec) following the first preliminary ejection. Thus, the ink in the small nozzles 103B is kept in a condition suitable for ejection. Furthermore, for the large nozzles 103A, after the second reciprocating scan following the preliminary ejection onto the ink reception section 32b is finished, the preliminary ejection onto the ink reception section 32b is carried out again. A time from the preliminary ejection onto the ink reception section 32b till the end of the second print scan (scan with ink ejection) is about 1.8 sec. This amount of time is insufficient for the ink to be thickened to cause an improper ejection in the large nozzles 103A.

Hence, the appropriate ejection performance can always be maintained for the large nozzles 103A. Furthermore, the preliminary ejection through the large nozzles 103A avoids being carried out on the print medium 24 and is thus prevented from affecting the image. Therefore, according to the present embodiment, the appropriate ejection performance is always maintained for the small nozzles 103B, which are likely to undergo an improper ejection, until the operation of printing an image is finished. This allows high-quality images to be formed. The present embodiment also enables a drastic reduction in the frequency of movement of the print head to the ink reception section for preliminary ejection. This allows high-speed printing to be accomplished.

In the above-described embodiments, the preliminary ejection is carried out on the ink reception section 32a. However, the preliminarily ejected ink may be received by the cap section 31.

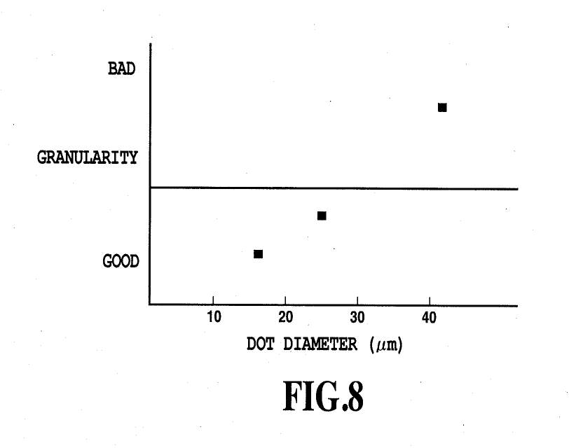

FIG. 8 is a diagram showing the results of plotting, for each black ink dot size, of the level of granularity observed when two droplets are ejected onto a blank print medium through each nozzle per print scan. In FIG. 8, the solid line corresponds to the level beyond which a dot pattern formed by preliminary ejection provides a sense of granularity and it is thus impossible to form further dots by the preliminary ejection.

FIG. 8 indicates that if a small dot formed by an ink droplet ejected through the small nozzle 103A has a diameter of smaller than about 30 μm, even when two ink droplets are dispersively ejected onto a blank print medium through each nozzle per print scan, the resulting image provides no sense of granularity. As is apparent from the results, if each small dot has a diameter of about 30 μm and 1-pass printing is performed in which the image in the scan area is completed during a single print scan, a preliminary ejection of about two droplets can be carried out for each nozzle during each print scan as is the case with the present embodiment.

### Second Embodiment

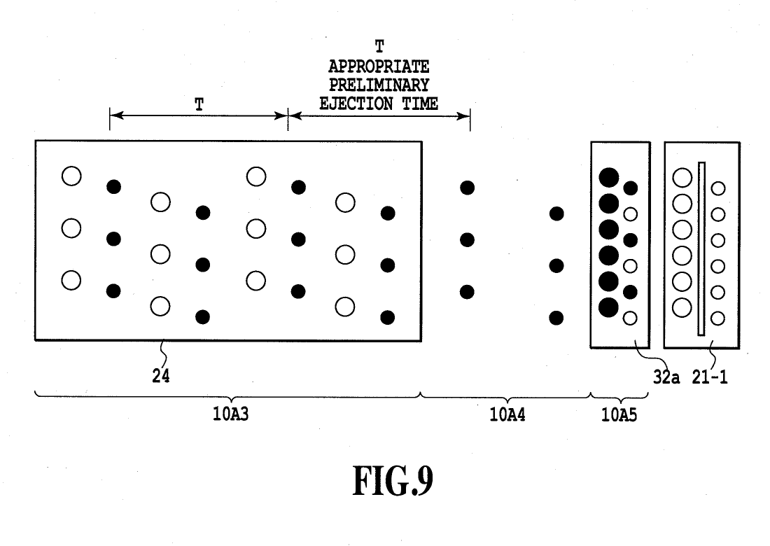

Now, a second embodiment of the present invention will be described with reference to FIG. 9. A printing apparatus according to the second embodiment is also configured as shown in FIG. 1 to FIG. 3. In FIG. 9, components that are the same as or correspond to those of the above-described first embodiment are denoted by the same reference numerals.

In the second embodiment, for bidirectional printing, such a preliminary ejection as shown in FIG. 9 is carried out with the print medium located far away from the ink reception section 32b in the main scanning direction (X direction). As shown in FIG. 9, the print medium located far away from the ink reception section 32b when for example, the print medium 24 is narrow in the main scanning direction. That is, if the print medium is narrow, a large gap is formed between the print medium 24 and the ink reception section 32a positioned closer to an away position S5 than the end of the print medium.

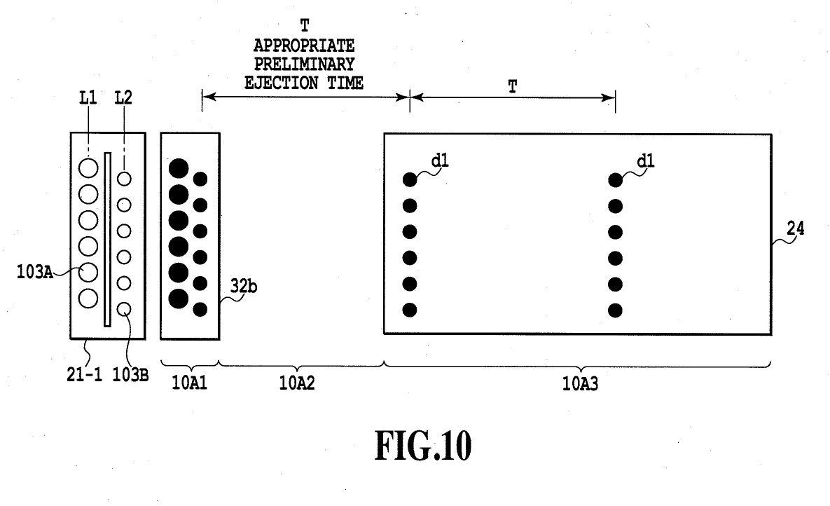

In this situation, even when preliminary ejection is almost simultaneously carried out on the ink reception section 32b closer to the home position and then the print head is moved to the print medium while being accelerated and idly fed, all the nozzles in the nozzle array almost simultaneously exceed the appropriate idle time. Thus, as shown in FIG. 10, a linear preliminary ejection needs to be carried out on the print medium 24. As a result, dots formed on the print medium by the preliminary ejection may be viewed as artifacts.

Thus, in the second embodiment, even in an idle area corresponding to an acceleration and deceleration area 10A4 in FIG. 9, a preliminary ejection of small droplets is carried out based on preliminary ejection data (third preliminary ejection data). In this case, the timing when the preliminary ejection is carried out on the idle scan area differs between the even nozzles and the even nozzles in the second nozzle array L2. This allows the timing for reaching the appropriate idle time on the print medium to differ between the odd nozzles and the even nozzles. Thus, the timing for the preliminary ejection onto the print medium through the even nozzles can be made different from that for the preliminary ejection onto the print medium through the odd nozzles. When the timing for the preliminary ejection onto the print medium through the even nozzles is different from that for the preliminary ejection onto the print medium through the odd nozzles, dots formed on the print medium are dispersed as shown in FIG. 9 and are thus difficult to view. Hence, the second embodiment enables degradation of the image quality to be alleviated. Furthermore, the droplet size is very small, thus minimizing the possibility that the preliminary ejection onto the idle scan area will cause the printing apparatus main body to be contaminated. Therefore, no problem occurs.

The driving of ejection of the ink onto the idle scan area can be performed similarly to the driving of ejection of the ink during image printing. However, ejection driving dedicated to preliminary ejection may be performed by controlling the amount power supplied to the electrothermal conversion element. Furthermore, for the large nozzles, one preliminary ejection is carried out on the ink reception section per two print scans (per reciprocating scan). Then, during printing, the ink in the large nozzles 103A can always be kept in a condition suitable for ejection. Furthermore, ink droplets preliminarily ejected through the large nozzles 103A are prevented from affecting the image. When the preliminary ejection through the large nozzles 103A is carried out on the ink reception section, preliminary ejection may be carried out through some or all of the smaller nozzles as required. Additionally, the preliminary ejection data (first preliminary ejection data) required to carry out preliminary ejection on the print medium as described above can be obtained by synthesizing preliminary ejection data with image data.

As described above, according to the second embodiment, preliminary ejection can be carried out through all the nozzles during the appropriate idle time. The ink is thus stably ejected though both the smaller nozzles and the larger nozzles, allowing high-quality image printing to be accomplished.

In the above-described second embodiment, the combination of the set of odd nozzles and the set of even nozzles is used as the combination of the set of nozzles undergoing the simultaneous preliminary ejection onto the idle scan area and the set of nozzles undergoing the simultaneous preliminary ejection onto the print medium. However, another combination of sets of simultaneously driven nozzles is possible provided that the combination allows dots formed on the print medium by the preliminary ejection to be dispersed so as to be visually discernable. Alternatively, each nozzle array may be divided into at least three sets of nozzles such that the sets involve different ink ejection timings.

### Third Embodiment

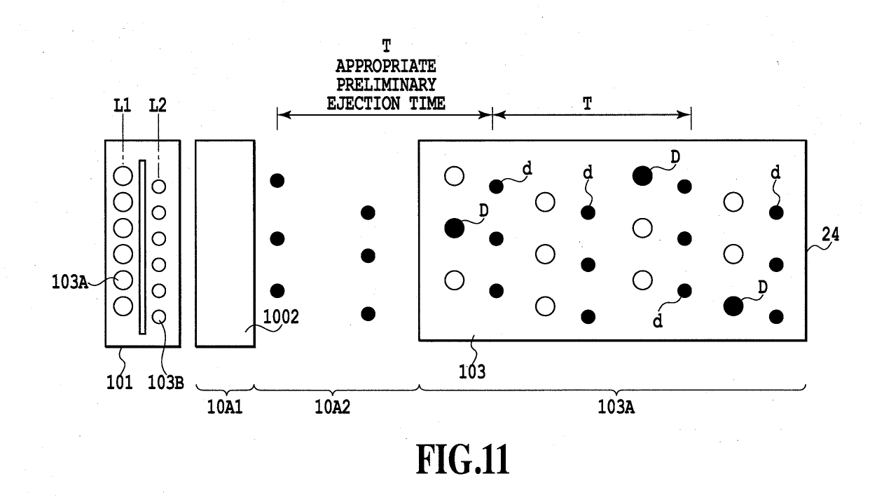

Now, a third embodiment of the present invention will be described with reference to FIG. 11. A printing apparatus according to the third embodiment is also configured as shown in FIG. 1 to FIG. 3. In FIG. 11, components that are the same as or correspond to those of the above-described first embodiment are denoted by the same reference numerals.

In the above-described second embodiment, the preliminary ejection through the large nozzles 103A is carried out only on the ink reception section. However, ink droplets ejected through the large nozzles 103A are very small, and dots formed on the print medium by the ink droplets are also very small. Thus, large dots formed by ink droplets ejected through the large nozzles 103A are prevented from severely affecting the image provided that only a small number of dots are dispersively formed on the print medium. Hence, in the third embodiment, with this condition taken into account, the preliminary ejection through the large nozzles 103A is carried out on the print medium together with the preliminary ejection through the small nozzles 103B. FIG. 11 is a diagram schematically showing how preliminary ejection is carried out during the first print scan. Here, for simplification of description, only the print head 21-1 configured to eject the cyan ink is shown as the print head.

As shown in FIG. 11, with the appropriate idle time for the large nozzles 103A taken into account, the preliminary ejection onto the print medium 24 through the large nozzles 103A may be carried out once per nozzle during two print scans. That is, 0.5 droplet is sufficient for each print scan. In this case, small dots (d) and large dots D are mixedly present on the print medium 29 in a given ratio; the small dots (d) are printed on the print medium 24 by the preliminary ejection through the small nozzles 103B, and the large dots D are printed on the print medium 24 by the preliminary ejection through the large nozzles 103A. The dots (large dots D and small dots (d)) in this dot pattern are dispersively arranged, and the number of large dots D is smaller than that of small dots (d). Thus, even if dots formed by the preliminary ejection are interposed among dots formed for image printing, the image quality is prevented from being degraded. Furthermore, for both the large nozzles and the small nozzles, the preliminary ejection is carried out during the appropriate idle time. Hence, during image printing, the ink in the nozzles can be kept in a condition suitable for ejection. This enables a substantial reduction in improper ejections in the nozzles.

### Fourth Embodiment

Now, a fourth embodiment of the present invention will be described.

The above-described third embodiment, in which the preliminary ejection through the large nozzles, is effective in the print mode in which the image in each scan area is completed by a small number of print scans (for example, one or two print scans). However, in a print mode in which high-quality images are formed, the image in each scan area is completed by a large number of print scans (hereinafter also referred to as passes). The preliminary ejection shown in the third embodiment may be unsuitable for such a high-image-quality print mode.

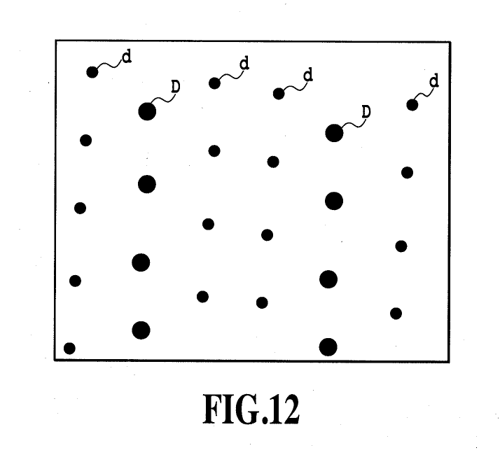

For example, in a multipass print mode in which the image in one scan area is completed by at least four passes, if the preliminary ejection according to the third embodiment is adopted, a large number of large dots are formed as shown in FIG. 12. This is because the preliminary ejection is carried out on the same scan area during every print scan. In this case, a dot pattern formed by the preliminary ejection may cause a different in density which is visually discernable against a white background or provide the formed print image with granularity.

Thus, in the fourth embodiment, in the high-image-quality print mode in which the image in the same scan area is formed by a large number of passes, the preliminary ejection through the small nozzles is carried out on the print medium. On the other hand, the preliminary ejection through the large nozzles is carried out on the ink reception section 32b. Such preliminary ejection can be accomplished by synthesizing only the preliminary ejection data for the small nozzles 103B with the image print data, while avoiding synthesizing the preliminary ejection data for the large nozzles 103A with the image print data. For such preliminary ejection, in the preliminary ejection through the large nozzles 103A, the print head is moved to the ink reception section 32a once every two print scans as shown in FIG. 9. Thus, precisely, compared to the third embodiment, in which all the preliminary ejections through the large and small nozzles are carried out on the print medium, the fourth embodiment requires an increased time for printing because of the need to move to the ink reception section 32a. However, in a 4-pass print mode or an 8-pass print mode, printing originally requires a long time, and throughput is thus low. Hence, an increase in time resulting from the movement to the ink reception section 32a does not substantially affect the throughput. Therefore, according to the fourth embodiment, even in the print mode in which the image in the same scan area is completed by a large number of passes, the ink in both the large and small nozzles can be kept in a condition suitable for ejection. Furthermore, the adverse effect of the preliminary ejection on the image can be reduced. This enables high-grade image printing to be accomplished.

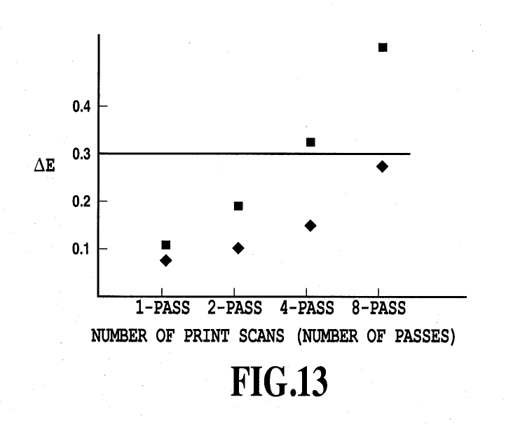

FIG. 13 is a diagram showing, in terms of color difference ΔE, the relationship between the number of print scans (the number of passes) and each of the level of coloring (♦) obtained when the preliminary ejection through only the small nozzles is carried out on a blank print medium and the level of coloring (▪) obtained when the preliminary ejection through both the large and small nozzles is carried out on a blank print medium. A solid line in FIG. 13 indicates the level beyond which the color difference between a dot pattern formed by the preliminary ejection and the ground color of the blank print medium is impermissible and it is thus impossible to form further dots on the print medium by the preliminary ejection.

As shown in FIG. 13, with the preliminary ejection with only the small nozzles, the level of coloring increases based on an increase in the number of print scans (the number of passes), but even the 8-pass printing results in a permissible color difference. However, if the required preliminary ejection is carried out through both the small and large nozzles, the 4- and 8-pass printing may result in an impermissible change in density.

Specifically, up the 2-pass print mode, up to 2 small dots of preliminary ejection pattern and up to 0.5 large dots of preliminary ejection pattern can be placed on the print medium during each print scan. However, in the 4- and 8-pass modes, when large and small dots are similarly preliminarily ejected onto the print medium, a density difference from the white background may be visually discernable. This indicates that the number of dots printed on the print medium by the preliminary ejection is limited.

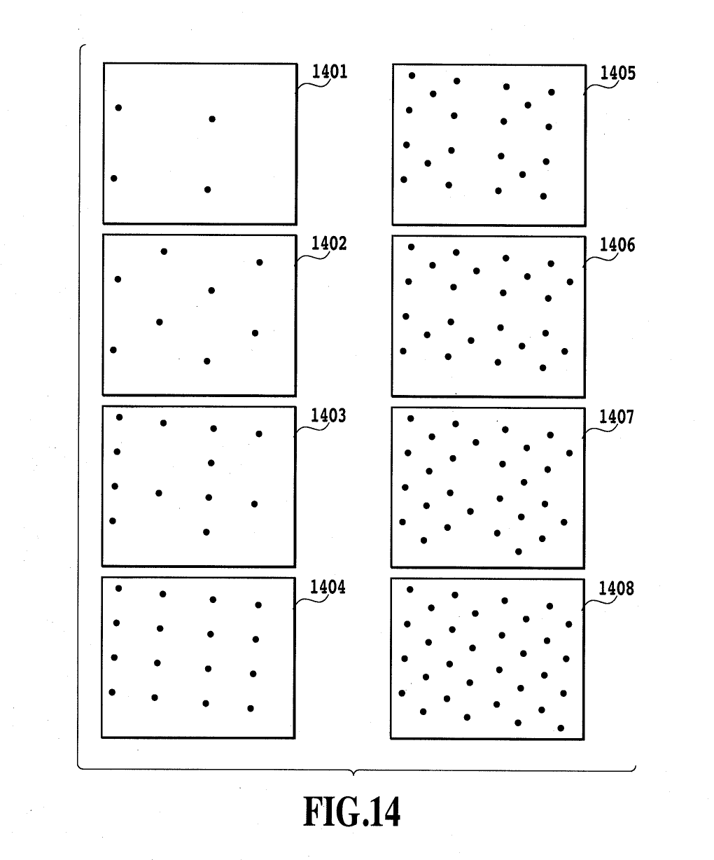

FIG. 14 is a diagram showing a dot pattern formed by the preliminary ejection onto the print medium through the small nozzles in each of the 1-pass print mode to the 8-pass print mode. In FIG. 14, patterns 1401, 1402, 1403, 1404, 1405, 1406, 1907, and 1408 correspond to print modes in which the respective patterns are formed by 1 pass, 2 passes, 4 passes, 5 passes, 6 passes, 7 passes, and 8 passes. Here, the dot pattern formed in the 1-pass print mode is compared with the dot pattern formed in the 2-pass print mode. The number of dots printed in the 2-pass print mode is twice as large as that of dots printed in the 1-pass print mode. The number of dots formed by the preliminary ejection increases consistently with the number of passes in the print mode. Thus, the dot pattern printed by the preliminary ejection in the 1- or 2-pass print mode provides a weak sense of granularity because of the small number of dots. This reduces the possibility of a density difference or a color difference. However, the dot pattern formed by the preliminary ejection in the print mode with at least 3 passes provides a sense of granularity that is stronger with progression of the number of dots. Furthermore, in this dot pattern, a density difference or a color difference from the white background is likely to occur.

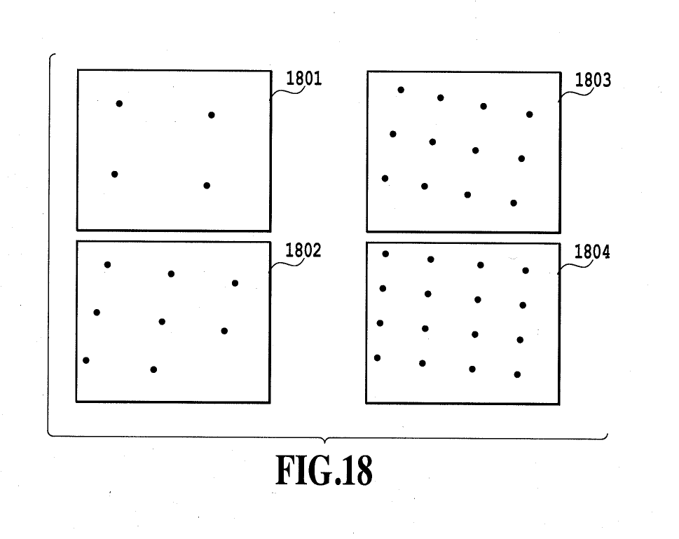

Furthermore, as seen in the dot patterns 1403, 1405, 1406, and 1907, granularity is visually discerned in a pattern in which dots are missing in some areas, that is, a pattern in which the dots are not spaced at equal intervals. Thus, if a dot pattern including a certain given number of dots is formed on the print medium by the preliminary ejection, the pattern is desirably selected to include dots spaced at equal intervals. For example, if a printing apparatus capable of executing the 1-pass print mode to 4-pass print mode is used to execute the 3-pass print mode, a sense of granularity can be more appropriately suppressed by forming a pattern shown at 1803 in FIG. 18 than by forming a pattern shown at 1403 in FIG. 14. Reference numerals 1801, 1802, 1803, and 1804 in FIG. 18 denote other examples of dot patterns to be formed on the print medium by the preliminary ejection in the 1-, 2-, 3-, and 4-pass print modes, respectively. As described above, in forming dots on the print medium by the preliminary ejection, a printing apparatus with plural types of print modes desirably forms the dots in a pattern suitable for each of the print modes. This can be accomplished by preparing plural types of preliminary ejection data suitable for the respective plural types of print modes, selecting any of the preliminary ejection data in accordance with a specified print mode, and synthesizing the selected preliminary ejection data with the image print data.

Furthermore, in the multipass printing scheme in which the same scan area is scanned a number of times, when an image is printed at the leasing and trailing ends of the print medium, not all the nozzles in the print head but a part of the nozzle array, that is, some nozzles arranged at the leading end of the nozzle array, are used to form an image. In this case, the other nozzles are not used. Thus, for printing of the leading end, the preliminary ejection may be carried out on the ink reception section immediately before a print scan used for the actual printing without the need to synthesize the print image data with the preliminary ejection data. That is, the print scan for printing of the leading and trailing ends in which the print head is moved to the ink reception section for the preliminary ejection may be mixed with the print scan for the other cases in which the preliminary ejection is carried out on the print medium as well as in the area in which the ink reception section is not located, without the need to move to the ink reception section.

### Other Embodiments

Furthermore, the present invention is applicable to the case where each ink color involves a plurality of contrasting densities. The present invention is also applicable to any different combination of the amounts of ink ejection through the large and small nozzles. Moreover, in the above description, the present invention uses the two types of nozzles, the large and small nozzles. However, the present invention is applicable to at least three types of nozzles with different ejection amounts.

Thus, according to the present invention, the image print data has only to be appropriately synthesized with the required preliminary ejection data in accordance with the number of print heads used, the types of ink colors, the print medium, the print speed, and the ink ejection amount for printing. The present invention is not particularly limited to the above-described embodiments.

Furthermore, the present invention is applicable not only to the serial ink jet printing apparatus but also to an inkjet printing apparatus configured to complete an image by a single print scan using a full-line print head in which nozzles are arranged all over the image print width of the print medium.

Furthermore, in the above-described embodiments, the print head is illustrated which ejects the ink through the nozzles using the energy of the electrothermal conversion elements provided in the respective nozzles. However, the present invention is not limited to this configuration. The present invention is also applicable to a printing apparatus using a head configured to eject the ink in accordance with a scheme other than the one based on the electrothermal conversion element; the ink is ejected by, for example, generating an electrostatic force in the nozzles or using piezoelectric elements arranged in the respective nozzles.

Moreover, the present invention is applicable to all apparatuses that use print media made of paper, cloth, leather, nonwoven cloth, OHP sheets, or metal. Examples of specific applied equipment include business equipment such as printers, copiers, and facsimile machines and industrial production equipment.

### Examples

The results of actual printing operations performed using the above-described embodiments will be described below.

### Example 1

A print head unit used was as shown in FIG. 2A. In a print head configured to eject cyan ink and magenta ink, 128 large nozzles and 128 small nozzles were arranged at a density of 1,200 dpi. An average of 2.4 ng of ink was ejected through each of the large nozzles. An average of 1.2 ng of ink was ejected through each of the small nozzles. Furthermore, in a print head configured to eject black ink and yellow ink, 256 large nozzles through each of which an average of 2.4 ng of ink was ejected were arranged at a density of 1,200 dpi.

An ink jet printing apparatus used was configured as shown in FIG. 1. The ink ejection frequency during printing was set to 30 kHz. The ink used was commercially available ink for iP4100 (manufactured by Canon Inc.; cyan, magenta, yellow, and black). The ink was arranged in order of C, M, X, K, M, and C. A4-sized ink jet-only photo gloss paper (Pro Photo Paper, PR101; manufactured by Canon Inc.) was used as print media.

Such a preliminary ejection pattern as shown at 1402 in FIG. 14 was placed on a white background, and forward and backward printing was performed in the 2-pass mode as shown in FIG. 10. No defect caused by a dot pattern formed on the print medium by the preliminary ejection through the small nozzles was visually observed in the image. Thus, high-quality printing was accomplished.

### Example 2

A print head and a ink jet printing apparatus similar to those in Example 1 were used, and 2L-sized ink jet-only photo gloss paper (Pro Photo Paper, PR101 2L; manufactured by Canon Inc.) was used as print media.

In this case, as shown in FIG. 9, the ink reception section 32a is located far away from the print medium during the backward printing. Thus, during the backward printing, in addition to the preliminary ejection onto the dedicated ink reception section, preliminary ejection onto another position was carried out as shown in FIG. 9, and printing was accomplished by reversing the print scan direction without the need to move the print head to the ink reception section 32a.

Thus, a printing time corresponding to the time for the movement and thus the time required for printing were reduced. Furthermore, favorable images with no part of the preliminary ejection pattern visually observed were printed.

### Example 3

As in the case Example 2, 2L-sized print media were used. Furthermore, as shown in FIG. 11, printing was performed in the 2-pass print mode with the preliminary ejection carried out on the print medium through both the large and small nozzles. As a result, the time required to move to the ink reception section and thus the time required for printing were reduced. Furthermore, favorable images with no part of the preliminary ejection pattern visually observed were printed.

### Example 4

An ink jet printing apparatus similar to that in Example 2 was used, and as in the case shown in FIG. 9, the print image data was synthesized with only the preliminary ejection data for the small nozzles. Bidirectional printing was performed in the 8-pass print mode. As a result, the printing time corresponding to the time for the movement and thus the time required for printing were reduced. Furthermore, favorable images with no part of the preliminary ejection pattern visually observed were printed.

### Comparative Example 1

An ink jet printing apparatus similar to that in Example 4 described above was used, and as shown in FIG. 11, the print image data was synthesized with both the preliminary ejection data for the large nozzles and the preliminary data for the small nozzles. Bidirectional printing was performed in the 8-pass print mode. As a result, the preliminary ejection pattern was visually observed, and low-quality images were printed.

### Example 5

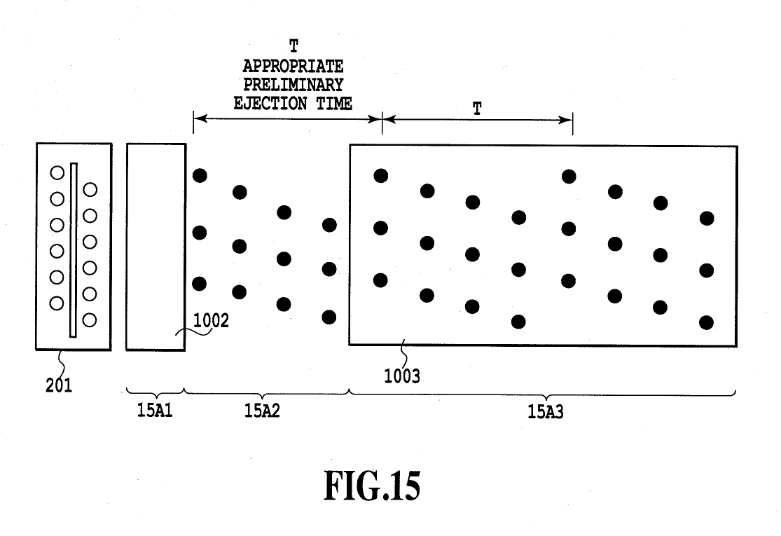

As shown in FIG. 15, a print head in which all the nozzles were small were used to perform bidirectional printing. In this case, images were printed in the 2-pass print mode, while in addition to the preliminary ejections onto the dedicated ink reception section and the print medium, preliminary ejection onto another position was carried out as shown in FIG. 15. The printing time corresponding to the time for the movement and thus the time required for printing were reduced. Furthermore, favorable images with no part of the preliminary ejection pattern visually observed were printed.

### Example 6

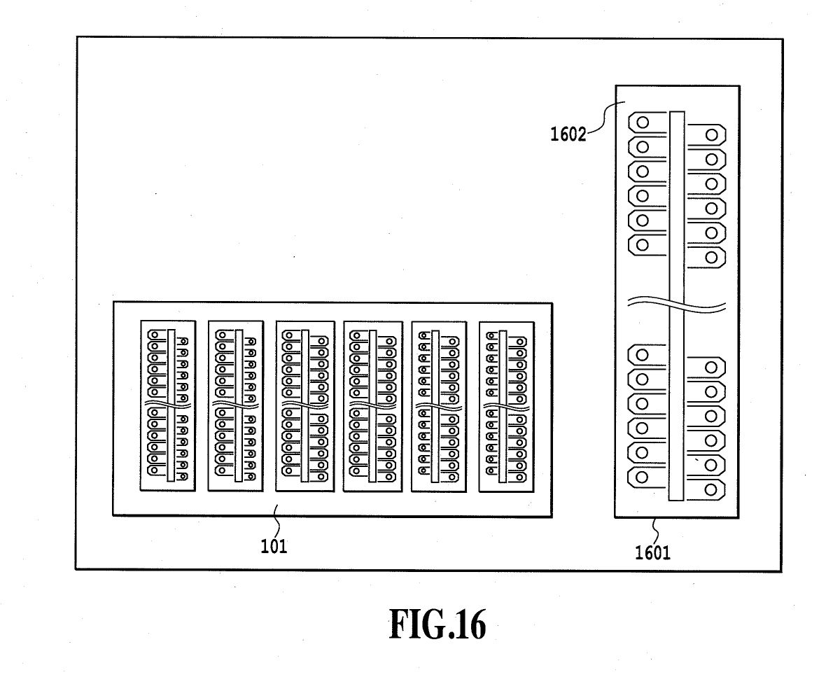

A print head shown in FIG. 16 was prepared. In FIG. 16, reference numeral 1601 denotes a print head, and reference numeral 1602 denotes a group of nozzles through which an extra large amount of droplets are ejected. Thirty pl of droplets can be ejected through each of the nozzles in the nozzle group 1601. The nozzles are arranged at a density of 600 dpi. Furthermore, reference numeral 101 denotes a group of print heads configured similarly to the head unit 21 shown in FIG. 2. The print head group and the print head 1601 form a head unit. Black ink is ejected through the nozzle group 1602.

A dot formed by droplets ejected through the nozzle group 1602 is about 80 μm in size. When a preliminary ejection pattern was printed on the print medium through the nozzle group 1602, granularity may be degraded or a color difference or a density difference may occur. Thus, a printing operation was performed with the data for the preliminary ejection through the nozzle group 1602 not synthesized with the print image data but with the data for the preliminary ejection through the small nozzles in the print head group 101 synthesized with the image print pattern.

### Example 7

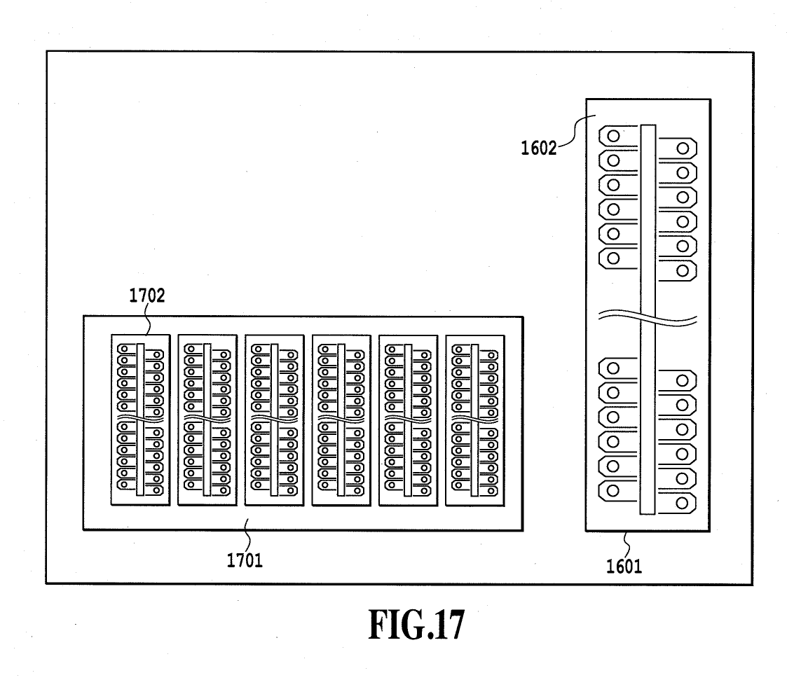

A print head shown in FIG. 17 was prepared. In FIG. 17, reference numeral 1702 denotes a print head with a group of 256 nozzles arranged at a density of 1,200 dpi and through each of which 1 pl of ink is ejected. Reference numeral 1701 denotes a print head group in which six such print heads are arranged. The six print heads are configured to eject black ink, cyan ink, magenta ink, yellow ink, magenta ink, and cyan ink. Furthermore, in FIG. 17, reference numeral 1602 denotes a print head configured similarly to the one shown in Example 6 described above. The print head 1602 and the print head group 1702 form a head unit 1601. The thus configured head unit 1601 was used to print images with the image print data synthesized with only the ejection data for the small nozzles in the print head group 1702 as in the case of Example 6. As a result, no part of the preliminary ejection pattern was visually observed, and high-quality images were successfully printed at high speed.

### Example 8

A print head and an ink jet printing apparatus similar to those in Example 1 were used, and data required to form a pattern shown in FIG. 18 was prepared as preliminary ejection data to be synthesized with the image print data. In FIG. 18, reference numeral 1801 denotes a pattern used for printing in the 1-pass print mode and allowing two preliminary ejections to be constantly provided through each nozzle for small droplets during each print scan. Furthermore, reference numerals 1802, 1803, and 1809 denote preliminary ejection dot patterns corresponding to the 2-pass print mode, the 3-pass print mode, and the 4-pass print mode, respectively. These patterns are set be most widely dispersed in the 9-pass print mode. The preliminary ejection dot patterns used in the print modes for at most three passes are normally set by decimating the dot pattern used in the 4-pass print mode. However, the use of such a pattern setting method may result in the degraded dispersibility of the pattern in a print mode for an indivisible pass number (in this case, the 3-pass print mode). As described above, the degraded dispersibility of the preliminary ejection pattern may provide a sense of granularity, thus deteriorating the image quality. Thus, in Example 8, preliminary ejection data was prepared which was designed to form a preliminary ejection dot pattern with improved dispersibility as shown at 1803. The preliminary ejection data was then synthesized with the preliminary ejection pattern for image printing. As a result, no part of the preliminary ejection pattern was visually observed, and high-quality images were successfully printed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-150072, filed Jun. 24, 2009, which is hereby incorporated by reference herein in its entirety.

What is claimed is:

1. An ink jet printing apparatus comprising:
a print unit configured to print dots of different sizes on a print medium based on image print data, by use of a print head including plural types of nozzles with different ejection amounts to eject ink onto the print medium; and,
a generation unit for generating preliminary ejection data for preliminary ejection,
wherein the generation unit generates preliminary ejection data designed to allow ink to be preliminarily ejected onto the print medium through those of the plurality of nozzles which have a smaller ejection amount than the other nozzles.

2. The ink jet printing apparatus according to claim 1, wherein the generation unit generates first preliminary ejection data designed to allow the ink to be preliminarily ejected onto the print medium through those of the plurality of nozzles which have a smaller ejection amount than the other nozzles and second preliminary ejection data designed to allow the ink to be preliminarily ejected to a position other than that of the print medium through the other nozzles.

3. The ink jet printing apparatus according to claim 1, wherein the generation unit generates first preliminary ejection data designed to allow the ink to be ejected onto the print medium through the nozzles with a smaller ejection amount than the other nozzles, second preliminary ejection data designed to allow the ink to be ejected onto a ink reception section located at a position different from that of the print medium, and third preliminary ejection data designed to allow the ink to be ejected onto a position different from those of the ink reception section and the print medium.

4. The ink jet printing apparatus according to claim 1, wherein the first preliminary ejection data is synthesized with the image data.

5. The ink jet printing apparatus according to claim 1, wherein the generation unit generates the first preliminary ejection data varying among different print modes.

6. An ink jet printing apparatus configured to use a print head including plural types of nozzles with different ejection amounts to eject ink onto a print medium based on image print data, thus forming dots of different sizes on the print medium, the apparatus comprising:
a generation unit for generating preliminary ejection data for preliminary ejection,
wherein the generation unit generates preliminary ejection data designed to allow ink to be preliminarily ejected, at a predetermined timing, onto the print medium through those of the plurality of nozzles which have a smaller ejection amount than the other nozzles, while allowing the ink to be preliminarily ejected, at a timing different from the predetermined timing, onto the print medium through the other nozzles.

7. The ink jet printing apparatus according to claim 6, wherein the generation unit generates preliminary ejection data designed to allow the ink to be ejected during an appropriate idle time that is a maximum idle time for which no improper ejection occurs in the nozzles.

8. The ink jet printing apparatus according to claim 6, wherein the print head comprises different types of nozzles arranged along predetermined directions, respectively, and
the generation unit allows the ink to be preliminarily ejected, at different timings, through those of the same type of plural nozzles arranged in the print head which are located at adjacent positions.

9. The ink jet printing apparatus according to claim 1, wherein the print head comprises a first nozzle through which a first predetermined amount of ink is ejected, and a second nozzle through which a second predetermined amount of ink is ejected, the second predetermined amount being smaller than the first predetermined amount.

10. The ink jet printing apparatus according to claim 1, wherein the print head comprises at least three types of nozzles through which different amounts of ink is ejected.

11. The ink jet printing apparatus according to claim 1, wherein the print head is allowed to scan the same scan area of the print medium a number of times, with the ink ejected from the print head, to complete an image to be printed in the same scan area.

12. An ink jet printing method of using a print head including plural types of nozzles with different ejection amounts to eject ink onto a print medium based on image print data, thus forming dots of different sizes on the print medium, the method comprising:
a generation step of generating preliminary ejection data for preliminary ejection,
wherein the generation step generates preliminary ejection data designed to allow ink to be preliminarily ejected onto the print medium through those of the plurality of nozzles which have a smaller ejection amount than the other nozzles.
